(19) United States
(12) Patent Application Publication
(10) Pub. No.: US 2007/0015126 A1
(43) Pub. Date: Jan. 18, 2007

(54) Computer kit for hobbyists and students

(76) Inventor: Paul Simon Sauer, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/180,973

(22) Filed: Jul. 13, 2005

(51) Int. Cl. G09B 19/00

(52) U.S. Cl. 434/224

(57) ABSTRACT

A wacky kit provides all the components and instructions for assembling a computer at home. The kit appeals to people looking for a fun project in which to engage. Power computer users and those already involved with current technology enjoy the kit because its features all the pieces necessary to construct functional servers, workstations and high-performance gaming machines. All manner of currently sold computing products can be quickly integrated and manipulated to make a kit for virtually any computing need.

### FIELD OF THE INVENTION

The present invention relates to computers, and particularly to hobby or educational kits for building a computer.

### BACKGROUND OF THE INVENTION

The present invention provides a simple, low cost, and easy to use computer kit that combines all the necessary equipment, tools, and instructions for anyone to construct a working, x86 architectural system in the comfort of their home, school or office. Even on a rainy day. The kit is an opportunity to introduce technology into the modern household for educational and entertainment purpose.

A Laboratory Computer Kit™ of the present invention is wacky. Hobbyists have fun with the theme of the Mad Scientist working in The Lab, creating all these weird devices. The kit appeals to people looking for a fun project in which to engage. Power computer users and those already involved with current technology enjoy the kit because it features all the pieces necessary to construct functional servers, workstations and high-performance gaming machines. All manner of currently sold computing products can be quickly integrated and manipulated to make a kit for virtually any computing need.

### BRIEF DESRIPTION OF THE DRAWINGS

The present invention is further described in the detailed description that follows, by reference to the noted drawings, by way of non-limiting examples of embodiments of the present invention, in which reference numerals represent similar features throughout the views of the drawings, and in which:

FIG. 1 is an isometric view of a specific embodiment of a computer kit of the present invention.

FIG. 2 is an isometric view of an alternative embodiment of a computer kit of the present invention.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with reference to PC personal computers. It is understood that a PC is merely an example of a specific embodiment of the present invention, which is directed broadly to computers, platforms, operating systems, and methods within the scope of the invention. The terminology, therefore, is not intended to limit the scope of the invention.

The kit provides a useful tool in the classroom and anywhere else that students of computing are taught the trade and aspects of it. Other uses for the kit are anyone who has children, and those who are curious as to how computers work and want to find out by looking at one first hand from Step 1.

A specific embodiment of the kit includes, but is not necessarily limited to, the following exemplary components:
1 Motherboard
1 CPU with Cooling Fan
CDRW
1 piece of DDR RAM
10/100 Network Card
56K Modem
32 MB Video Card
Floppy Drive
Case with Power Supply
Hard Disk
Microsoft Windows XP Home
Utilities disk (Benchmark programs and other “freeware” utilities to collect data from their creation and share with other Mad Scientists.)
Lab Coat and Protective Goggles.
Instructional Video and Manual
Laboratory Authentication Badge

Alternative embodiments include a monitor and/or a monitor connection cable. Other alternative embodiments provide a kit for a laptop computer, including an integral monitor.

A kit of the present invention is affordable and provides a good value for the cost. People may register their functional kits and perform distributed computing tasks using the internet.

Complete assembled kits entitle the creator to join groups of other successful creators and enjoy fellowship and group support, as well as take the computers to meetings to show and compare, just as one would a model car or plane.

Specific add-ons to kits are contemplated in various alternative embodiments to provide kits suitable for particular user segments, including:

Education Series Kits include software that teaches the computing basics, such as programming and primary electronics. These kits run all of the software supported by Intel and AMD. They are suitable for many different aspects of education, such as High School and College customers.

Audio Series Kits contain software and hardware to help the home musician/producer mix and master original recordings as they see fit. These kits include high-end sound cards capable of professional grade recording and playback, audio production software such as Fruity Loops, Cake Walk, Acid and more from the top software houses.

Video Series Kits provide Windows Movie Maker and video cameras.

Photography Series Kits provide Photoshop and printer cables for photo editing and printing.

Pro Gaming Series Kits appeal to the Monster product demographic and include the highest performance cards from NVidia and ATI needed to run the latest game titles, some of which are included in the kit. Bundles of games, peripherals and more are included in alternative embodiments of the kit.

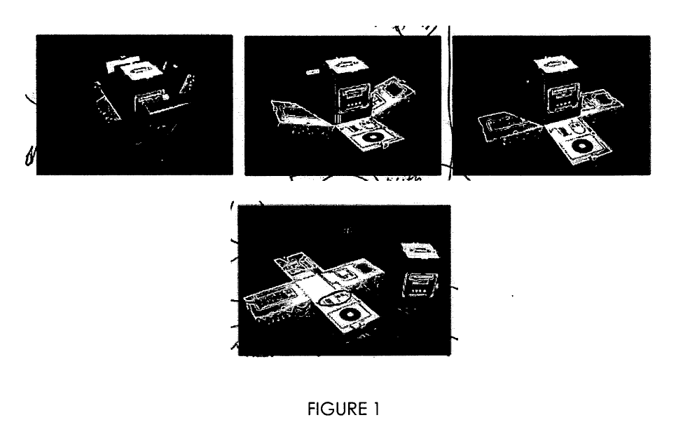

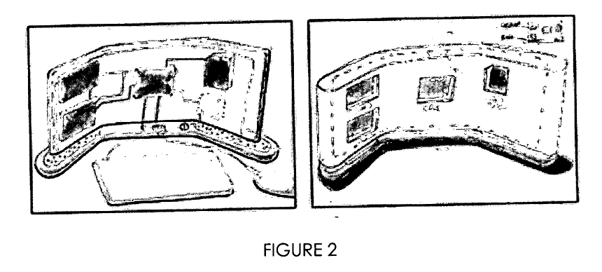

FIGS. 1 and 2 depict alternative embodiments of a package for a kit of the present invention. FIG. 1 is an isometric view of a specific embodiment of a computer kit of the present invention. Opening the package provides a fun, dynamic experience. Each container leaf explains the contents of the container, such as, for example, the hard drive (HD), the motherboard, CPU, CDRW, and so forth. The center chassis box is detachable and can be used to transport the assembled computer.

FIG. 2 is an isometric view of an alternative embodiment of a computer kit of the present invention. The embodiment of FIG. 2 provides vertically oriented components for easy visibility. Specific alternative embodiments provide a clear housing for the assemble computer to provide a “visible computer” embodiment.

The packaging enhances the playfulness of the kit, provides a work space for assembling the kit components, and organizes the components so that they are easy to locate and identify.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

I claim:

1. A kit to build a computer, the kit comprising:
at least one Motherboard;
at least one CPU with Cooling Fan;
at least one CDRW;
at least one piece of DDR RAM;
at least one 10/100 Network Card;
at least one 56K Modem;
at least one 32 MB Video Card;
at least one Floppy Drive;
at least one Case with Power Supply;
at least one Hard Disk;
software; and
a set of instructions.

2. The kit of claim 1, further comprising at least 1 Lab Coat.

3. The kit of claim 2, further comprising one or more protective goggles.

4. The kit of claim 2 further comprising one or more Laboratory Authentication Badge.

5. The kit of claim 1, wherein the instructions further comprise one or more Instructional Manual.

6. The kit of claim 1, wherein the instructions further comprise one or more Instructional Video.

7. The kit of claim 1, wherein the software further comprises Microsoft Windows XP Home.

8. The kit of claim 1, wherein the software further comprises a Utilities software disk

9. The kit of claim 1, wherein the software further comprises Benchmark programs and other “freeware” utilities.

10. The kit of claim 1, wherein the software further comprises audio recording and playback software.

11. The kit of claim 1, further comprising computer gaming hardware and software.

12. The kit of claim 1, further comprising video hardware and software.

13. The kit of claim 1, further comprising photography hardware and software.

14. The kit of claim 1, further comprising packaging to contain the kit components.

15. The kit of claim 1, further comprising a monitor connection cable.

16. The kit of claim 1, further comprising a monitor and a monitor connection cable.

17. The kit of claim of 1, further comprising an integral monitor, wherein the kit is for a laptop computer.
